(19) United States
(12) Patent Application Publication
(10) Pub. No.: US 2023/0274126 A1
(43) Pub. Date: Aug. 31, 2023

(54) GENERATING PREDICTIONS VIA MACHINE LEARNING

(71) Applicant: PayPal, Inc., San Jose, CA (US)

(72) Inventors: Ramnarayan Vijapur Gopinath Rao, Chennai (IN); Rajkumar Baskaran, Vellore (IN); Rishabh Goel, Palwal (IN)

(21) Appl. No.: 17/682,953

(22) Filed: Feb. 28, 2022

(51) Int. Cl. G06N 3/04; G06N 3/08; G06K 9/62; G06F 40/20

(52) U.S. Cl. CPC G06N 3/0445; G06N 3/08; G06K 9/6223; G06K 9/6256; G06F 40/20

(57) ABSTRACT

A plurality of first entities have been previously associated with a predefined activity. By performing a clustering algorithm on the first entities, a subset of the first entities is identified that have met a predefined criterion. Via a Natural Language Processing (NLP) technique, a multi-dimensional matrix is generated. The matrix has a plurality of vectors associated with attributes of the subset of the first entities. A neural network model is trained with the multi-dimensional matrix. A plurality of second entities are on a list that contains entities that have been flagged for engaging in, or having engaged, the predefined activity. Based on the trained neural network model, a prediction is made whether scanning the second entities against a plurality of third entities for matches will cause a number of alerts having a predefined characteristic to exceed a predefined threshold. The alerts correspond to matches that needs further investigation.

### BACKGROUND

The present disclosure generally relates to machine learning, and more particularly, to using machine learning to predict spikes in alerts on networked computer systems.

### RELATED ART

Rapid advances have been made in the past several decades in the fields of computer technology and telecommunications. These advances have led to more and more operations being conducted online, which has attracted the attention of malicious actors. Computer security breaches perpetrated against online entities can be costly, and thus it is important to screen the malicious entities. The screening may generate alerts, which need to be investigated further to determine if the alerts are accurate. However, the alerts may not be generated at a steady pace but may have spikes in volume. These spikes in the alerts make the investigation thereof more difficult, since a steady amount of resources is often deployed to conduct such investigations. Making matters worse, certain types of alerts may require specialized resources for the investigation, which existing systems have not been able to predict and deploy ahead of the alerts spikes. Therefore, although existing systems and methods of handling alerts are generally adequate for their intended purposes, they have not been entirely satisfactory in every aspect.

### BRIEF DESCRIPTION OF THE DRAWINGS

FIG. 1 is a block diagram that illustrates a process flow according to various aspects of the present disclosure.

FIG. 2 is a simplified block diagram of a networked system according to various aspects of the present disclosure.

FIGS. 3-4 are flowcharts illustrating processes that leverage machine learning according to various aspects of the present disclosure.

FIG. 5 is an example computer system for implementing the various steps of the methods or processes discussed in FIGS. 1-4 according to various aspects of the present disclosure.

FIG. 6 is a simplified example of an example artificial neural network according to various aspects of the present disclosure.

FIG. 7 is a simplified example of a cloud-based computing architecture according to various aspects of the present disclosure.

### DETAILED DESCRIPTION

It is to be understood that the following disclosure provides many different embodiments, or examples, for implementing different attributes of the present disclosure. Specific examples of components and arrangements are described below to simplify the present disclosure. These are, of course, merely examples and are not intended to be limiting. Various attributes may be arbitrarily drawn in different scales for simplicity and clarity.

As computing and communication technologies continue to advance, electronic activities become increasingly more prevalent. For example, more and more people are using the Internet to perform various daily tasks such as banking, buying goods/services, consuming media, paying bills, etc. However, the popularity of online transactions has also led to an increasing number of malicious activities being perpetrated against online merchants or users, such as scams, fraud, hacking, carding attacks, phishing, spamming, etc. To mitigate or prevent these malicious activities, various organizations such as governmental agencies may collect data about perpetrators of such malicious activities. A service provider may obtain a list of these malicious actors and screen the malicious actors on the list against the service provider's own customers or users. If a match is found, an alert is generated, which warrants further investigation to determine whether the matched customer/user is indeed the same entity as the one on the malicious actors list. The service provider may then report the positively identified customers/user to the appropriate authorities (often within a given short time window) and/or take necessary action against these customers/users, for example, by suspending or terminating their accounts.

One problem is that the alerts generated by the scan may not have a steady or consistent volume, but may have spikes or surges in volume from time to time. Such spikes make it difficult to conduct the investigation, since the resources (e.g., personnel and/or computing systems) deployed for the investigation ahead of the alerts may not be equipped to handle the spike in volume. This situation is exacerbated when specialized resources are required to investigate the alerts involved in the spikes. For example, the alerts involved in a spike may be associated with a particular geographical region and/or a particular language. As such, investigators who are familiar with the geographical region or fluent in the language may be needed to effectively investigate the alert to determine whether the match found is a true match. Unfortunately, existing systems and methods are unable to predict the spikes in alerts ahead of time, let alone what geographical region, language, event, or holiday is associated with the spikes. As a result, conventional systems and methods have been inefficient in handling the alerts.

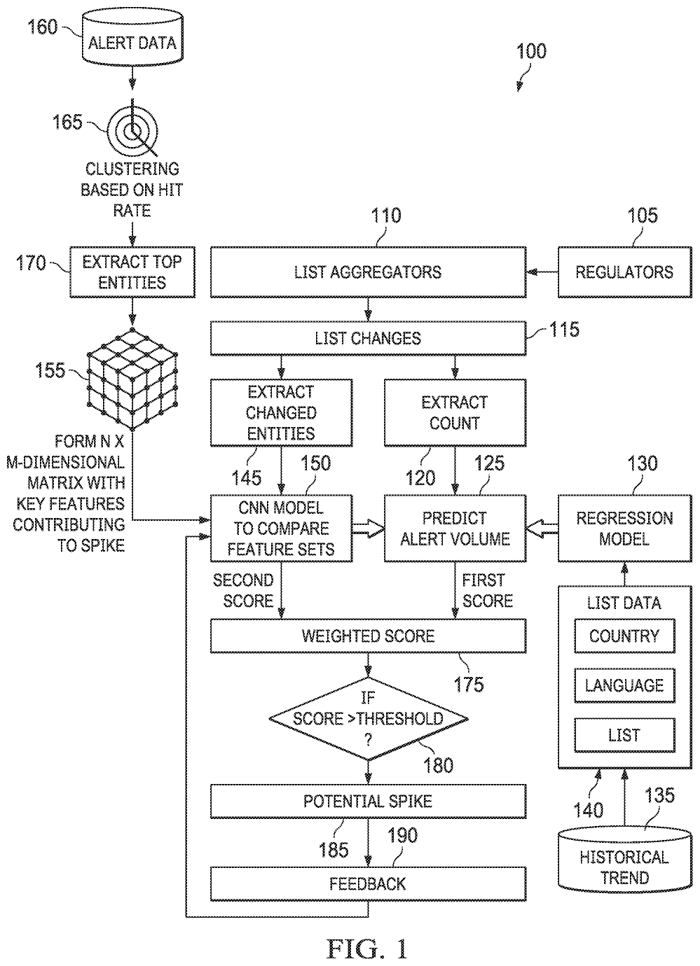

The present disclosure is directed to systems and methods of using machine learning to make more accurate predictions regarding the alerts. The historical data of previously identified malicious actors is obtained and analyzed to determine which of the malicious actors have historically contributed more to the spikes in volume of alerts than other malicious actors. A Natural Language Processing technique such as word2vec is applied to the attributes or features (e.g., name, address, occupation, etc.) of these top contributing malicious actors to generate a multi-dimensional matrix. The matrix is used to train a Neural Network model, for example, by feeding the matrix into successive layers of a Convolutional Neural Network (CNN) model. In addition, the data of a service provider's own customers/users who have confirmed matches with actors on the malicious actors list is used to train a regression model. The trained regression model and the trained CNN model are used to generate a weighted score that predicts whether a spike in alerts will be generated, including the geographical region and/or language associated with the spike. The various aspects of the present disclosure will be discussed below in more detail with reference to FIGS. 1-7.

FIG. 1 is a simplified block diagram illustrating a process flow 100 according to the various aspects of the present disclosure. First, a list of entities is flagged by a regulator 105. These entities may have been flagged as having engaged in, or currently engaging in, a predefined activity, such as a fraudulent activity or a malicious or suspicious activity, as non-limiting examples. The fraudulent activity may include as stolen financials, account takeovers, spamming, counterfeiting, hacking, phishing, man-in-the-middle attacks, man-in-the-browser attacks, forgery, unauthorized alteration of electronic documents, etc. The malicious or suspicious activity may include hijackings, hostage takings, kidnappings, shootings, car bombings, suicide bombings, or other activities with intent to injure or otherwise harm other entities. The entities that engage in these predefined activities may be a person or an organization. The regulators 105 may include government agencies such as the Office of Foreign Assets Control (OFAC), Interpol, Better Business Bureau (BBB), Federal Bureau of Investigations (FBI), Central Intelligence Agency (CIA), National Security Agency (NSA), etc. In some embodiments, the regulators 105 may also include commercial institutions such as credit rating agencies such as EXPERIAN™, EQUIFAX™, or TRANSUNION™.

List aggregators 110 obtain the flagged list of bad actor entities from the regulators 105 and compile a more comprehensive and/or organized list. In some embodiments, the list aggregators 110 may include entities such as WORLD CHECK™ or ACCUITY™. The list aggregators 110 may obtain the lists of bad actors from the regulators 105 on a periodic basis. It is understood that the compiled list may contain different types of information regarding the entities. As non-limiting examples, the different types of information may include name, phone number, address, age, date of birth, gender, occupation, citizenship, current location, country of residence, passport number, countries/regions visited, education level, credit score, accounts with various institutions (e.g., bank accounts), etc. These types of information may be in textual format and are electronically searchable via the compiled list.

A service provider (e.g., PAYPAL™) may obtain the compiled bad actor list from the list aggregator 110 and then electronically scan the list against a list of customers or users of the service provider to identify potential matches. If a match is identified, it may indicate that the customer or user may be associated with flagged activities (e.g., fraudulent activities) and should be reported to the authorities. Furthermore, the service provider may take certain actions against the customers/users on the matched list, for example, by blocking or suspending the accounts of these customers/users.

However, sometimes the match yields a false positive, meaning that the matched customer or user is not actually associated with the flagged activities. For example, a person on the list of flagged entities may happen to have the same name (and/or other characteristics) as a customer/user of the service provider, who is a completely different person. Reporting the innocent customer/user of the service provider to the authorities or blocking/suspending his/her account not only risks upsetting and losing the customer/user, but it would also do very little in terms of preventing further fraud. Therefore, although the matches identified by the electronic scan discussed above may generate actionable alerts, these alerts need to be investigated further to determine which of the matches are true positives.

Conventional approaches have relied on dedicated resources (e.g., a relatively fixed team of people who may work a steady schedule) to conduct such investigations. Unfortunately, the conventional approaches have various shortcomings. For example, the conventional approaches cannot predict, ahead of time, the volume of alerts that will be generated as a result of electronically scanning the obtained lists of bad actor entities against a service provider's own customers/users. In other words, while a dedicated team with a relatively fixed amount of resources may be generally adequate to handle an average amount of alert volume, it may not be equipped to handle sudden spikes (e.g., the number of alerts exceeding a predefined threshold within a predefined period of time) in the alert volume. Making matters worse, the spikes in the volume of alerts may often times be associated with a particular geographical region and/or a particular language. In order to effectively investigate these types of alerts, the investigation team needs to have personnel who are familiar with the geographical region and/or proficient in the language associated with the alerts, which is not the case with the conventional approaches.

To overcome the problems discussed above, the process flow 100 of the present disclosure trains various machine learning models in order to be able to predict the sudden spikes in the volume of alerts, as well as certain characteristics of the spikes, such as the geographical region and/or the language associated with the spikes. This allows the service provider to deploy needed resources (e.g., additional personnel, particularly personnel who are proficient in the language associated with the spikes, and/or route more computing resources) to the investigation team. In this manner, even if there are spikes in the volume of the generated alerts (which may also require specialized language skills), the investigation team can still efficiently investigate the alerts to reduce the false positive matches and to identify the bad actor customers/users with better accuracy, as discussed in more detail below.

Still referring to FIG. 1, the process flow 100 includes a step 115 in which list changes are determined. For example, a service provider may periodically receive the bad actors list from the list aggregator 110. The service provider may compare the most recently received bad actors list received from the list aggregator 110 with a previously received bad actors list from the list aggregator 110. Based on the comparison, a count may be extracted in step 120. The extracted count may include the new entities that are now on the most recently obtained bad actors list but that did not exist on the previous version of the bad actors list. In other words, the extracted count obtained in step 120 reflects the newly added bad actor entities. In some embodiments, the extracted count may also include entities that appear on both the previous list and the current list of bad actors but that experienced a change (e.g., a change in location).

The extracted count is then used to predict or forecast an alert volume in step 125. In that regard, if the extracted count comes in at a large volume, it is likely that the volume of alerts generated (as a result of electronically scanning the bad actors list against the service provider's own customers/users) will also increase. In order to accurately predict or forecast how much the volume of alerts will increase, the process flow 100 first trains a regression model 130. In more detail, the regression model 130 is a machine learning model that is trained using historical trend data 135. The historical trend data 135 may be stored in an electronic database and may include historical data about the alerts that were previously generated by electronically scanning the bad actors list against the service provider's own customers/users. In that regard, alert data may include the attributes (e.g., name, address, occupation, travel history, etc.) of the entities that are the target of each alert. For example, a scan of a person named David Johnson on the bad actors list against the service provider's own customer/user list triggered 10 alerts, where each alert corresponds to a customer/user of the service provider having a matching name (which may not necessarily be identical, since a name may have various spellings, such as Dave or Davey for David), and as well as other matching attributes as the David Johnson on the bad actors list. In this simple example, the corresponding alert data may include the name David Johnson on the bad actors list, the names of potential matching customers/users of the service provider (e.g., Dave Johnson), other matching attributes (e.g., age, occupation, travel history, etc.), as well as the number of the resulting alerts generated.

The historical trend data 135 may be obtained by analyzing the alert data to determine the historical trends of the matched customers/users of the service provider. For example, such an analysis may yield historical trend data 135 that includes list data 140, which includes attributes such as the country, language, and/or a list of names of the service provider's own customers/users who have been matched with entities on the bad actors list. The historical trend data 135 may indicate how the list data 140 changes with each received list of bad actors, e.g., which customers/users of the service provider are matched with the bad actors on each received list, including the country, language, or names of the customers/users on that particular list.

The historical trend data 135—including the list data 140—is used to train the regression model 130. In that regard, the regression model provides a function that describes a relationship between one or more independent variables (e.g., the received bad actors list in this case) and a response or a target variable (e.g., the customers/users matched with entities on the bad actors list in this case). In some embodiments, the training of the regression model 130 uses a Gradient Boosting technique. In other embodiments, the training of the regression model 130 uses a Simple Linear Regression technique. As a part of training the regression model, the model may try to find the best set of hyper parameters to predict the output. For example, the model may try to fit in from a range of hyperparameters given and from mathematical equations moves towards the hyper parameters with minimum error in training data. This information may be provided to the model as to how many epochs need to be run. The number of epochs can be optimized to avoid both over-fitting and under-fitting. This can also be optimized using test data set. Regardless of the technique used, the resulting trained regression model 130 can be used to predict the volume of the alerts that will be generated with any given incoming list of bad actors. Specifically, the step 125 may feed the extracted count (of the incoming bad actors list) obtained in step 120 to the regression model 130, which may then produce an output that helps to predict the number of alerts that will be generated in any given geographical region and/or associated with any given language. In some embodiments, the output of the step 125 includes a first score, which may be directed to or associated with a selected geographical region and/or language in some embodiments. The generation of the first score is one aspect of the process flow 100 of the present disclosure. As discussed below, the process flow 100 also generates a second score, which is then used in combination with the first score to predict potential spikes of alerts in any given geographical region and/or language.

Before the second score can be generated, the list changes determined in step 115 is used to extract the attributes of the changed entities. As discussed above, the changed entities may include the new entities that have been added to the bad actors list, and/or the existing entities on the bad actors list whose attributes have changed. As non-limiting examples, the changed attributes may include changes in name, age, gender, address, occupation, citizenship, passport number, current location, travel history, credit score, etc., of the existing entity on the bad actors list. The attributes of the entities extracted in step 145 are then fed as an input to a machine learning model 150 to calculate the second score. In some embodiments, the machine learning model includes a neural network model, for example, a Convolutional Neural Network (CNN) model. A CNN model uses a machine learning algorithm that can take in an input (e.g., a vector), assign an importance (e.g., learnable weights and biases) to various aspects of the vector, to differentiate the vectors from one another. In other embodiments, other neural network models may be used (in lieu of, or in addition to, the CNN model) to assign importance (e.g., within a threshold, or within a specific variance, etc.). For example, an a Long-Short Term Memory (LSTM) model, it may take a vector as the input and assign an importance (e.g., learnable weights and biases) to various aspects of the vector, in order to differentiate the vectors from one another. Similar to other Neural Network models, LSTM models can have multiple hidden layers, and as it passes through every layer, relevant information is kept, and all the irrelevant information gets discarded in every single cell. LSTM models may be very useful when dealing with long sequence of text inputs, which may make them well-suited to various aspects of the present disclosure, particularly with respect to certain geographical regions corresponding to certain languages.

Just as the regression model needs to be trained before it can be used to make predictions or forecasts, the CNN model also has to be trained first. In the illustrated embodiment, the CNN model is trained using a multi-dimensional matrix of word vectors. In some embodiments, the multi-dimensional matrix may be a two dimensional matrix, where one dimension represents the number of words in each attribute, and another dimension represents the dimension of output dimension of each word from word2vec algorithm, as will be discussed below in more detail. In the illustrated embodiment, the multi-dimensional matrix is generated in step 155, which involves accessing alert data 160, performing a clustering algorithm on the alert data in step 165, and extracting the top entities that have historically caused spikes in alerts in step 170. As discussed above, the alert data may include attributes such as name, address, occupation, travel history, etc., of the entities that are on the bad actors list. However, not all entities on the bad actors list will have an equal impact on the resulting alerts that will be generated when the bad actors list is scanned against the service provider's own customers/users. On the contrary, some entities on the bad actors list may have an outsized or disproportionate impact on the resulting alerts. For example, a person with a popular name (e.g., Smith, Lee, Kim, or Mohammed) on the bad actors list may lead to many matching alerts, regardless of whether the customers/users involved in the matching alerts are indeed the same underlying entity on the bad actors list. The clustering algorithm performed in step 165 helps to identify these top contributing bad actors that have historically created spikes in the volume of alerts. In some embodiments, the clustering algorithm includes a K-means clustering algorithm.

After the top contributing bad actors have been identified in step 165, the attributes associated with them are extracted in step 170. Again, these extracted attributes may include name, phone number, address, age, date of birth, gender, occupation, citizenship, current location, country of residence, passport number, countries/regions visited, education level, credit score, bank accounts, etc. The extracted attributes may be in textual format, for example, in a given language (e.g., English).

Since it is difficult to do computations on data in textual format, a Natural Language Processing (NLP) technique may be used in step 155 to convert the textual format information extracted from step 170 into data in vector format, which contains numbers, rather than letters. The NLP techniques may reveal the underlying patterns of the attributes associated with the top contributing bad actors (in terms of causing spikes in alerts historically). In some embodiments, the NLP techniques include a word2vec technique. In more detail, word2vec is a neural net that processes textual data by vectorizing words. For example, an input of a word2vec process may be a body of text (e.g., the attributes associated with the top contributing bad actors), and an output of the word2vec process may be a set of vectors, for example attribute vectors that represent words in those attributes. Therefore, for a given identified set of top contributing bad actors, each word in the attributes may have a corresponding vector, and the entirety of the textual data of that set of top contributing bad actors may be represented as a vector-space. Word2vec may be useful because it can group the vector representations of similar words together in a vector-space. This may be done by detecting their similarities mathematically, since mathematical operations may be performed on or using vectors. In this manner, word2vec allows mathematical processing (which is very convenient for computers) on human language data, which may make word2vec well-suited for machine learning, particularly in the context of the present disclosure. For example, word2vec is trained in the specific context of identifying the attributes that tend to cause spikes in alerts.

In the illustrated embodiment, an n×m matrix (as a two-dimensional matrix) is generated as a result of the step 155. In such a matrix, m represents the number of words converted in each attribute of the top contributing bad actors that have been identified (and whose attributes have been extracted), and n represents the output dimension of each word from word2vec algorithm. The n×m matrix is then fed into successive model layers of the CNN model to train the CNN model, so that the trained CNN model is able to recognize which attributes are likely to cause spikes in alerts. The trained CNN model 150 is used to compare the attributes of the n×m matrix with the attributes extracted from the step 145 of the incoming list of bad entities to determine what degree of correlation exists. As a result of this comparison and based on the determined degree of correlation, CNN model 150 outputs the second score discussed above.

In a step 175 of the process flow 100, a weighted score is generated based on the first score (outputted by step 125) and the second score (outputted by CNN model 150). The first score has a first weighting as a first component of the weighted score, and the second score has a second weighting as a second component of the weighted score. The weighting of the first score may be different from the weighting of the second score. As discussed above, a different weighted score may be generated with respect to each particular geographical region (e.g., Mexico) and/or each particular language (e.g., Spanish) in various embodiments.

In a step 180, the weighted score is compared with a predefined threshold score. Since the weighted score may be directed to a particular geographical region and/or a particular language, the predefined threshold score may also be directed to the particular geographical region and/or the particular language as well. For example, each geographical region and/or each language may have a different predefined threshold score in some embodiments.

If the weighted score exceeds the predefined threshold score, a step 185 will predict that a potential spike in alerts will be generated if the incoming bad actors list is scanned against the service provider's customers/users. In some embodiments, depending on how much the weighted score exceeds the predefined threshold score, the step 185 can predict the amount or degree of spike in alerts. For example, if the weighted score exceeds the predefined threshold score by less than 10% of the predefined threshold score, the step 185 may predict that the volume of alerts will be between about 200% and 300% of the average volume of alerts. If the weighted score exceeds the predefined threshold score by between 10% and 20% of the predefined threshold score, the step 185 may predict that the volume of alerts will be between about 300% and 400% of the average volume of alerts. If the weighted score exceeds the predefined threshold score by between 20% and 30% of the predefined threshold score, the step 185 may predict that the volume of alerts will be between about 400% and 500% of the average volume of alerts.

In addition, this prediction may be directed to a particular geographical region and/or a particular language. This is very beneficial for the service provider, since the service provider now knows which type of resources (e.g., personnel with certain language skills) need to be deployed ahead time, so that when the spike in volume of alerts is generated by the scan of the bad actors list, the already deployed resources will be able to conduct the investigation of the alerts quickly and efficiently.

In a step 190 of the process flow, feedback is provided to the CNN model to tune the CNN model for better accuracy. For example, the feedback may include the actual volume of alerts generated, and how that compares with the predicted volume of alerts. If the actual volume is not as high as the predicted volume, the CNN model may be adjusted to be less aggressive about its prediction, and vice versa. In this manner, the feedback loop may improve the accuracy of the CNN model, so that each subsequent prediction is more on target. In other words, the various model parameters of the CNN model (or other models used to make predictions) may be updated with each iteration of the feedback loop, so that the CNN model with the updated model parameters may be able to make better predictions with each iteration of the feedback loop. Again, the feedback may be customized for a specific geographical region and/or a specific language, or even for a predefined event or holiday. For example, the prediction and the feedback may be customized for Mexico (as an example of a geographical region) and for Spanish (as an example of a language), which may predict that between October 10^{th} through 11^{th}, there will be a spike of alerts concerning users located in mexico, and Spanish is needed to effectively and efficiently conduct the investigation.

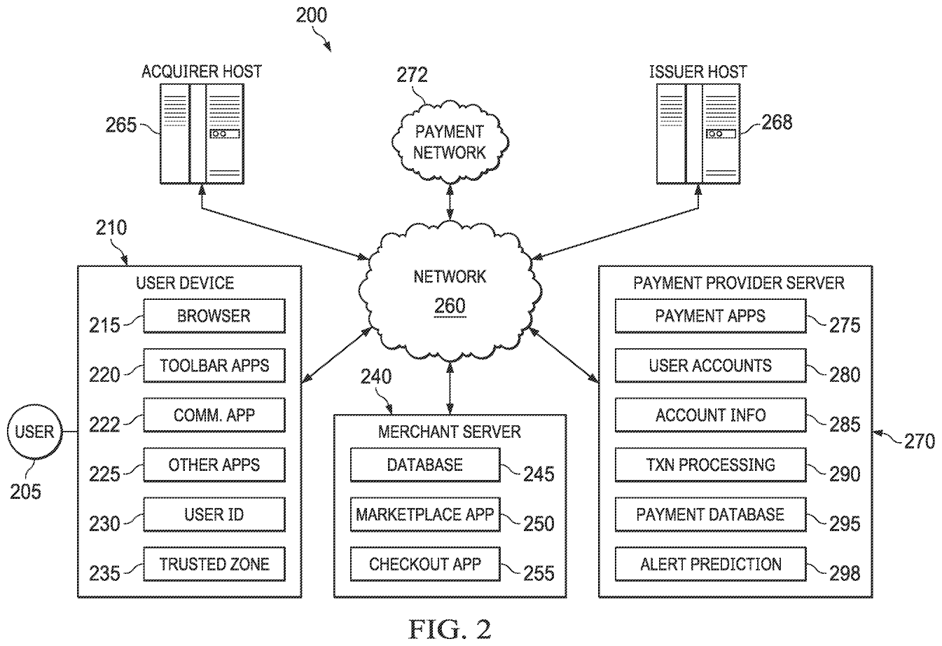

FIG. 2 is a block diagram of a networked system 200 suitable for conducting electronic transactions according to the various aspects of the present disclosure. The flagged activities discussed above with reference to FIG. 1 may arise in the context of conducting these electronic transactions. The networked system 200 may comprise or implement a plurality of hardware devices and/or software components that operate on the hardware devices to perform various payment transactions or processes. Exemplary devices may include, for example, stand-alone and enterprise-class servers operating a server OS such as a MICROSOFT™ OS, a UNIX™ OS, a LINUX™ OS, or another suitable server-based OS. It can be appreciated that the servers illustrated in FIG. 2 may be deployed in other ways and that the operations performed, and/or the services provided by such servers may be combined or separated for a given implementation and may be performed by a greater number or fewer number of servers. One or more servers may be operated and/or maintained by the same or different entities. Exemplary devices may also include mobile devices, such as smartphones, tablet computers, or wearable devices. In some embodiments, the mobile devices may include an APPLE™ IPHONE™, an ANDROID™ smartphone, or an APPLE™ IPAD™, etc.

In the embodiment shown in FIG. 2, the networked system 200 may include a user device 210, a merchant server 240, a payment provider server 270, an acquirer host 265, an issuer host 268, and a payment network 272 that are in communication with one another over a network 260. The payment provider server 270 may be maintained by a payment service provider, such as PAYPAL™, Inc. of San Jose, Calif. A user 205, such as a consumer, may utilize user device 210 to perform an electronic transaction using payment provider server 270. For example, user 205 may utilize user device 210 to initiate a payment transaction, receive a transaction approval request, or reply to the request. Note that a transaction, as used here, refers to any suitable action performed using the user device, including payments, transfer of information, display of information, etc. Although only one merchant server is shown, a plurality of merchant servers may be utilized if the user is purchasing products from multiple merchants.

User device 210, merchant server 240, payment provider server 270, acquirer host 265, issuer host 268, and payment network 272 may each include one or more electronic processors, electronic memories, and other appropriate electronic components for executing instructions such as program code and/or data stored on one or more computer readable mediums to implement the various applications, data, and steps described here. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks. Software programs (e.g., programs developed by the payment provider or by another entity) may be installed on the network 260 to facilitate the offer solicitation, transmission, and presentation processes discussed above. The network 260 may also include a blockchain network in some embodiments.

User device 210 may be implemented using any appropriate hardware and software configured for wired and/or wireless communication over network 260. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an IPHONE™ or IPAD™ from APPLE™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet, such as a user account for online shopping and/or merchant sites for viewing and purchasing goods and/or services.

Still referring to FIG. 2, the user device 210 may also include one or more toolbar applications 220 which may be used, for example, to provide client-side processing for performing desired tasks in response to operations selected by user 205. In one embodiment, toolbar application 220 may display a user interface in connection with browser application 215.

User device 210 also may include other applications 225 to perform functions, such as email, texting, voice and IM applications that allow user 205 to send and receive emails, calls, and texts through network 260, as well as applications that enable the user to communicate, transfer information, make payments, and otherwise utilize a digital wallet through the payment provider as discussed here. In some embodiments, these other applications 225 may include a mobile application downloadable from an online application store (e.g., from the APPSTORE™ by APPLET™). The mobile application may be developed by the payment provider or by another entity, such as an offer aggregation entity. The mobile application may then communicate with other devices to perform various transaction processes. In some embodiments, the execution of the mobile application may be done locally without contacting an external server such as the payment provider server 270. In other embodiments, one or more processes associated with the execution of the mobile application may involve or be performed in conjunction with the payment provider server 270 or another entity. In addition to allowing the user to receive, accept, and redeem offers, such a mobile application may also allow the user 205 to send payment transaction requests to the payment service provider server 270, which includes communication of data or information needed to complete the request, such as funding source information.

User device 210 may include one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider. A communications application 222, with associated interfaces, enables user device 210 to communicate within networked system 200.

In conjunction with user identifiers 230, user device 210 may also include a trusted zone 235 owned or provisioned by the payment service provider with agreement from a device manufacturer. The trusted zone 235 may also be part of a telecommunications provider SIM that is used to store appropriate software by the payment service provider capable of generating secure industry standard payment credentials as a proxy to user payment credentials based on user 205's credentials/status in the payment providers system/age/risk level and other similar parameters.

Note that the user 205 may be a legitimate user, but it also may include the flagged entities discussed above with reference to FIG. 1. Therefore, one aspect of the present disclosure involves using machine learning to determine whether users (such as user 205) that matched up with entities on the bad actors list are actually the bad entities (e.g., a true positive), or not (e.g., a false positive). For example, the payment provider server 270 and/or the merchant server 240 may make these determinations via the machine learning processes discussed above in FIG. 1.

Still referring to FIG. 2, the merchant server 240 may be maintained, for example, by a merchant or seller offering various products and/or services. The merchant may have a physical point-of-sale (POS) store front. The merchant may be a participating merchant who has a merchant account with the payment service provider. Merchant server 240 may be used for POS or online purchases and transactions. Generally, merchant server 240 may be maintained by anyone or any entity that receives money, which includes charities as well as retailers and restaurants. For example, a purchase transaction may be payment or gift to an individual. Merchant server 240 may include a database 245 identifying available products and/or services (e.g., collectively referred to as items) which may be made available for viewing and purchase by user 205. Accordingly, merchant server 240 also may include a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also may include a checkout application 255 which may be configured to facilitate the purchase by user 205 of goods or services online or at a physical POS or store front. Checkout application 255 may be configured to accept payment information from or on behalf of user 205 through payment provider server 270 over network 260. For example, checkout application 255 may receive and process a payment confirmation from payment provider server 270, as well as transmit transaction information to the payment provider and receive information from the payment provider (e.g., a transaction ID). Checkout application 255 may be configured to receive payment via a plurality of payment methods including cash, credit cards, debit cards, checks, money orders, or the like. The merchant server 240 may also be configured to generate offers for the user 205 based on data received from the user device 210 via the network 260.

Payment provider server 270 may be maintained, for example, by an online payment service provider which may provide payment between user 205 and the operator of merchant server 240. In this regard, payment provider server 270 may include one or more payment applications 275 which may be configured to interact with user device 210 and/or merchant server 240 over network 260 to facilitate the purchase of goods or services, communicate/display information, and send payments by user 205 of user device 210.

The payment provider server 270 also maintains a plurality of user accounts 280, each of which may include account information 285 associated with consumers, merchants, and funding sources, such as credit card companies. For example, account information 285 may include private financial information of users of devices such as account numbers, passwords, device identifiers, usernames, phone numbers, credit card information, bank information, or other financial information which may be used to facilitate online transactions by user 205. Advantageously, payment application 275 may be configured to interact with merchant server 240 on behalf of user 205 during a transaction with checkout application 255 to track and manage purchases made by users and which and when funding sources are used.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment using various selected funding instruments, as described here. As such, transaction processing application 290 may store details of an order from individual users, including funding source used, credit options available, etc. Payment application 275 may be further configured to determine the existence of and to manage accounts for user 205, as well as create new accounts if necessary.

The payment provider server 270 may also include an alert prediction module 298 that is configured to predict alerts in accordance with the process flow 100 discussed above. For example, the alert prediction module 298 may include modules to access the historical data of bad actors, modules to access the incoming list of entities that have been flagged as being bad actors, modules to perform the clustering process to identify the top bad actors, modules to perform the word2vec algorithm to generate the multi-dimensional matrix, modules to train the CNN model, modules to train the regression model, modules to generate the first and second scores, and modules to evaluate whether a spike in alerts will be generated in a particular geographical region or language based on the first and second scores. It is understood that although the alert prediction module 298 is shown to be implemented on the payment provider server 270 in the embodiment of FIG. 2, it may be implemented on the merchant server 240 (or even the acquirer host 265 or the issuer host 268) in other embodiments.

The payment network 272 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 265 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 268 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

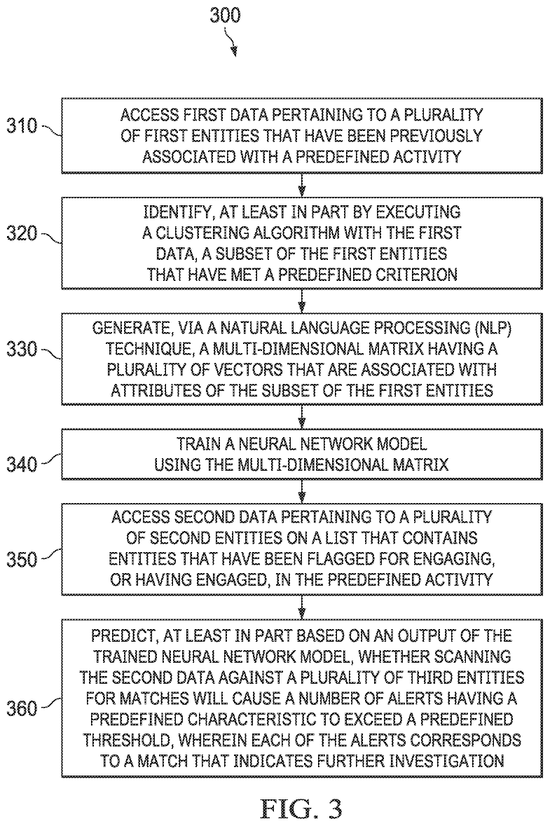

FIG. 3 is a flowchart illustrating a method 300 for performing machine learning processes according to various aspects of the present disclosure. The various steps, details of which are discussed here and not repeated below for conciseness, of the method 300 may be performed by one or more electronic processors, for example by the hardware processors of a computer of a service provider. In some embodiments, at least some of the steps of the method 300 may be performed by the alert prediction module 298 discussed above.

The method 300 includes a step 310 to access first data pertaining to a plurality of first entities that have been previously associated with a predefined activity.

The method 300 includes a step 320 to identify, at least in part by executing a clustering algorithm with the first data, a subset of the first entities that have met a predefined criterion.

The method 300 includes a step 330 to generate, via a Natural Language Processing (NLP) technique, a multi-dimensional matrix having a plurality of attributes associated with the subset of the first entities.

The method 300 includes a step 340 to train a neural network model using the multi-dimensional matrix.

The method 300 includes a step 350 to access second data pertaining to a plurality of second entities on a list that contains entities that have been flagged for engaging, or having engaged, in the predefined activity.

The method 300 includes a step 360 to predict, at least in part based on an output of the trained neural network model, whether scanning the second data against a plurality of third entities for matches will cause a number of alerts having a predefined characteristic to exceed a predefined threshold. Each of the alerts corresponds to a match that indicates further investigation.

In some embodiments, the predefined activity comprise a flagged activity. In some embodiments, the accessing second data comprises obtaining the list of the second entities from an aggregator. In some embodiments, the third entities are current users of the service provider.

In some embodiments, the performing the clustering algorithm comprises performing a K-means algorithm.

In some embodiments, the subset of the first entities comprises first entities that have previously generated matches with the third entities that exceeded the predefined threshold.

In some embodiments, the attributes are in textual format, and the multi-dimensional matrix is generated by applying a word2vec algorithm as the NLP technique to coverts the attributes in textual format into the vectors of the multi-dimensional matrix.

In some embodiments, the training the neural network model comprises running the multi-dimensional matrix through successive Convolutional Neural Network (CNN) model layers.

In some embodiments, the predefined characteristic comprises a geographical region associated with the matches or a language associated with the matches.

It is understood that additional steps may be performed before, during, or after the steps 310-360 discussed above. For example, the method 300 may include a step to train a regression model at least in part using the first data, and a step of forecasting, at least in part based on the regression model, a total volume of the alerts. In some embodiments, the predicting further comprises: calculating a first score based on the forecasted total volume; determining, based on the trained neural network model, a correlation between attributes of the subset of the first entities and attributes of the second data; calculating a second score based on the correlation; determining, in response to a sum of the first score and the second score exceeding a predefined score, that scanning the second data against a plurality of third entities for matches will cause the number of alerts having the predefined characteristic to exceed the predefined threshold. In some embodiments, the method 300 may further include a step of tuning the neural network model via a feedback loop. For reasons of simplicity, other additional steps are not discussed in detail here.

FIG. 4 is a flowchart illustrating a method 400 for performing machine learning processes according to various aspects of the present disclosure. The various steps, details of which are discussed here and not repeated below for conciseness, of the method 400 may be performed by one or more electronic processors, for example by the hardware processors of a computer of a service provider. In some embodiments, at least some of the steps of the method 300 may be performed by the alert prediction module 298 discussed above.

The method 400 includes a step 410 to access data pertaining to an incoming list of actors that are currently flagged for engaging in one or more predefined activities.

The method 400 includes a step 420 to access historical data pertaining to a plurality of actors that have previously engaged in the one or more predefined activities.

The method 400 includes a step 430 to perform a first machine learning process at least in part by using a regression model trained on the historical data.

The method 400 includes a step 440 to calculate a first score using the trained regression model and the data pertaining to the incoming list of actors.

The method 400 includes a step 450 to perform a second machine learning process at least in part by using a neural network model trained on the historical data.

The method 400 includes a step 460 to calculate a second score using the trained neural network model and the data pertaining to the incoming list of actors.

The method 400 includes a step 470 to calculate a weighted score based on the first score and the second score.

The method 400 includes a step 480 to predict, based on the weighted score, whether scanning the incoming list of actors against a list of users for matches will cause a number of the matches to exceed a predefined threshold.

In some embodiments, the historical data comprises historical data of actors that, when scanned against the list of users, caused the number of the matches to exceed the predefined threshold.

In some embodiments, the historical data comprises historical data associated with a predefined geographical region or with a predefined language. In some embodiments, the training the first machine learning process comprises training a Gradient Boosting model as the regression model using the historical data associated with the predefined geographical region or with the predefined language.

In some embodiments, the accessing the data pertaining to the incoming list of actors further comprises extracting a number of entities that changed between the incoming list and a prior version of the list. In some embodiments, the calculating the first score further comprises predicting a number of the matches by feeding the extracted number of the entities that changed to the trained regression model. The first score is calculated based on the predicted number of the matches.

In some embodiments, the accessing the data pertaining to the incoming list of actors further comprises extracting attributes of entities that changed between the incoming list and a prior version of the list. In some embodiments, the calculating the second score further comprises determining a correlation between the extracted attributes and attributes of the actors that have previously engaged in the one or more predefined activities. In some embodiments, the determining the correlation comprising feeding the extracted attributes to the trained neural network model. The second score is calculated based on the determined correlation.

In some embodiments, wherein the neural network model comprises a Convolutional Neural Network (CNN) model, and wherein the training the neural network model comprises: generating a multi-dimensional matrix of vectors, the vectors being associated with attributes of the actors that have previously engaged in the one or more predefined activities; and passing the multi-dimensional matrix through successive layers of the CNN model.

In some embodiments, the generating the multi-dimensional matrix comprises applying a word2vec algorithm to the attributes of the actors that have previously engaged in the one or more predefined activities, wherein the attributes are in a textual format before the word2vec algorithm is applied.

It is understood that additional steps may be performed before, during, or after the steps 410-480 discussed above. For example, the method 400 may further include a step of tuning the neural network model via a feedback loop. For reasons of simplicity, other additional steps are not discussed in detail here.

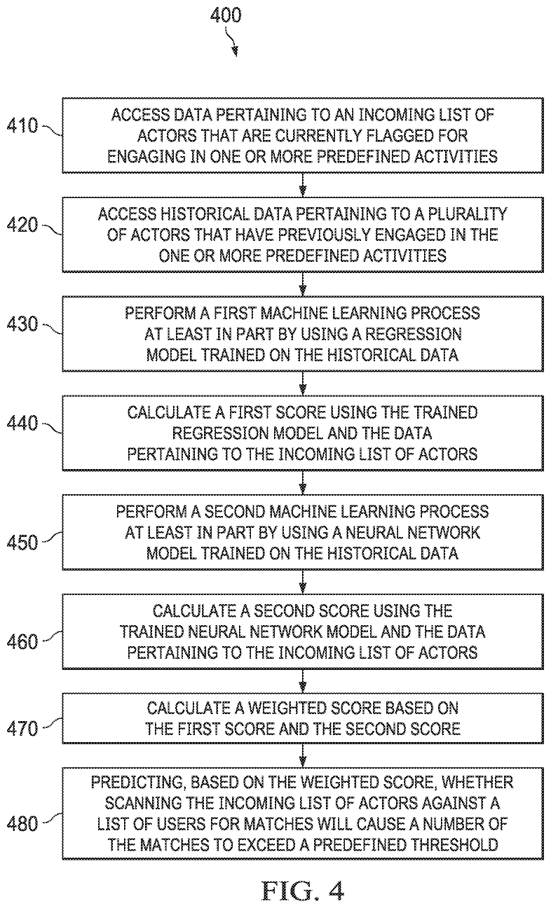

FIG. 5 is a block diagram of a computer system 500 suitable for implementing various methods and devices described herein, for example, the payment provider server 270, the merchant server 240, the user device 210, the computers of the acquirer host 265, the computers of the issuer host 268, or portions thereof. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the various machine learning models discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the various devices herein.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the alert prediction module 298 discussed above may be implemented as such software code in some embodiments.

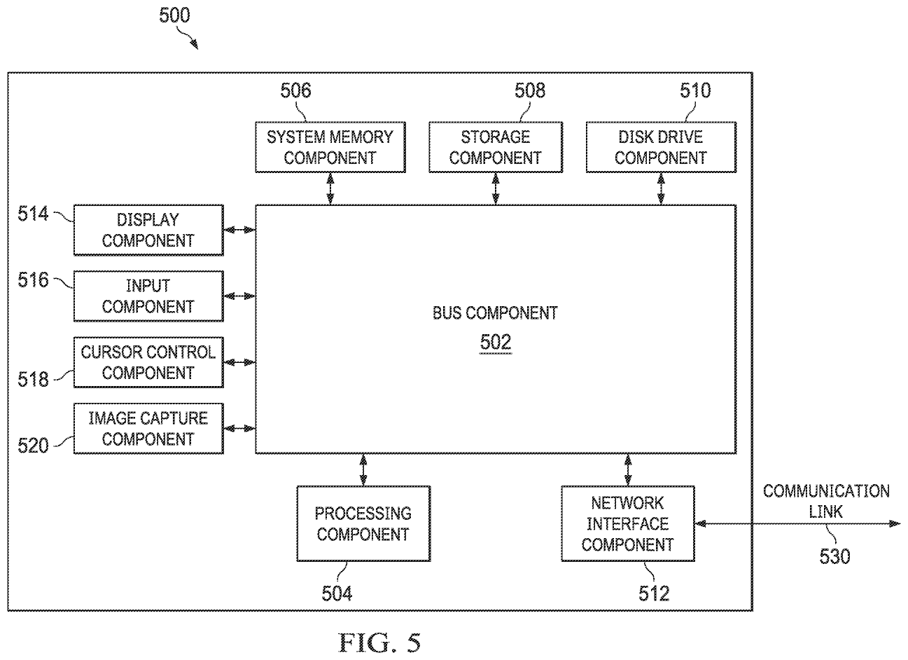

The machine learning processes discussed above may be implemented using a variety of machine learning techniques. As a non-limiting example, the machine learning may be performed at least in part via an artificial neural network. In that regard, FIG. 6 illustrates an example artificial neural network 600, which may be used at least in part to build the CNN model of FIG. 1 discussed above. The artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 may include as many hidden layers as necessary. In this example, the artificial neural network 600 receives a set of input values and produces an output value. Each node in the input layer 602 may correspond to a distinct input value.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning models herein, the output value produced by the artificial neural network 600 may indicate a likelihood of an event (e.g., likelihood of fraud).

The artificial neural network 600 may be trained by using training data. For example, the training data herein may be the features extracted from historical data, for example, historical data pertaining to the bad actors on previous lists and/or the service provider's customers/users that matched with the bad actors. By providing training data to the artificial neural network 600, the nodes 616-618 in the hidden layer 604 may be trained (adjusted) such that an optimal output (e.g., the most relevant feature) is produced in the output layer 606 based on the training data. By continuously providing different sets of training data, and penalizing the artificial neural network 600 when the output of the artificial neural network 600 is incorrect (e.g., when the determined (predicted) likelihood is inconsistent with whether the event actually occurred for the transaction, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

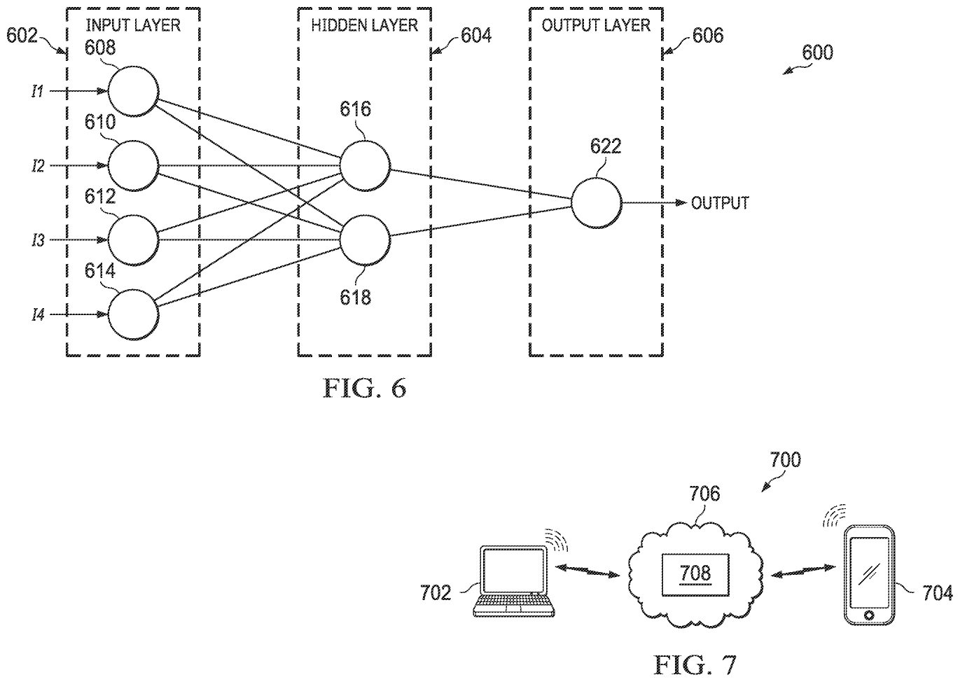

FIG. 7 illustrates an example cloud-based computing architecture 700, which may also be used to implement various aspects of the present disclosure. The cloud-based computing architecture 700 includes a mobile device 704 (e.g., the user device 210 of FIG. 2) and a computer 702 (e.g., the merchant server 240, the payment provider server 270), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, certain components for performing the various machine learning processes discussed above may reside on a mobile device, while other components for performing the machine learning processes discussed above may reside on the payment provider server 270 or on the merchant server 240.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the machine learning process as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

Based on the above discussions, it can be seen that the present disclosure offers several significant advantages over conventional methods and systems. It is understood, however, that not all advantages are necessarily discussed in detail here, different embodiments may offer different advantages, and that no particular advantage is required for all embodiments. One advantage is improved functionality of a computer. For example, conventional computer systems have not been able to accurately predict the alert spikes generated when scanning an incoming list of bad actors against a service provider's own customers/user, much less the geographical region or language associated with these alert spikes. In contrast, the computer system of the present disclosure performs various machine learning processes to generate more accurate predictions of the alert spikes. For example, historical data of the customers/users of the service provider is used as training data to train a regression model (e.g., a Gradient Boosting model), so that the trained regression model is usable to predict a first score based on the extracted count of entity changes between an incoming list and a previous list of bad actors. In addition, a clustering process is applied to historical alert data to identify the top contributing bad actors (e.g., contributing more to the generation of alerts). A word2vec algorithm is applied to the attributes of these top contributing bad actors to convert the attributes from textual format into vectors, thereby generating a multi-dimensional matrix of word vectors. The multi-dimensional matrix is then used to train a CNN model, so that the trained CNN model is usable to predict a second score based on a comparison between the extracted attributes of bad actors on an incoming list with the attributes of the matrix. The first and second scores are used to generate a weighted score, which is compared with a predefined threshold score to determine whether a potential spike of alerts will occur if the incoming list of bad actors is scanned against the service provider's own customers/users. The trained models may be directed to selected geographical regions and/or languages, and thus the prediction regarding the alert spikes may also be directed to the selected geographical regions and/or languages. Therefore, the present disclosure improves computer functionality by turning an ordinary computer into a versatile tool in alert prediction, which allows the service provider to deploy needed resources to investigate the alerts before the alerts are generated. The machine learning processes used to implement the present disclosure allows the computer system herein to achieve a speedy and yet accurate result in the alert prediction, which is something that would not have been possible using conventional computers.

The inventive ideas of the present disclosure are also integrated into a practical application, for example into the alert prediction module discussed above. Such a practical application can generate a more accurate alert prediction for each incoming list of bad actors, including the geographical region and/or language associated with the alert spikes, and it can significantly reduce costs related to fraud prevention.

The ordered combination of steps used to perform the present disclosure (e.g., the process flow 100 of FIG. 1) is also unique. For example, these steps involve training different machine learning models using different types of data, generating a weighted score based on the training machine learning models, determining potential spikes based on the weighted score, and using a feedback loop to improve the accuracy of the predictions. Such an ordered combination of steps is unique and not found in conventional schemes.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method that includes the following steps: accessing first data pertaining to a plurality of first entities that have been previously associated with a predefined activity; identifying, at least in part by performing a clustering algorithm on the first data, a subset of the first entities that have met a predefined criterion; generating, via a Natural Language Processing (NLP) technique, a multi-dimensional matrix having a plurality of vectors that are associated with attributes of the subset of the first entities; training a neural network model with the multi-dimensional matrix; accessing second data pertaining to a plurality of second entities on a list that contains entities that have been flagged for engaging in, or having engaged, the predefined activity; and predicting, at least in part based on the trained neural network model, whether scanning the second data against a plurality of third entities for matches will cause a number of alerts having a predefined characteristic to exceed a predefined threshold, wherein each of the alerts corresponds to a match that needs further investigation.

Another aspect of the present disclosure involves a system that includes a non-transitory memory and one or more hardware processors coupled to the non-transitory memory and configured to read instructions from the non-transitory memory to cause the system to perform operations comprising: accessing data pertaining to an incoming list of actors that are currently flagged for engaging in one or more predefined activities; accessing historical data pertaining to a plurality of actors that have previously engaged in the one or more predefined activities; performing a first machine learning process at least in part by training a regression model based on the historical data; calculating a first score based on the trained regression model and data pertaining to the incoming list of actors; performing a second machine learning process at least in part by training a neural network model based on the historical data; calculating a second score based on the trained neural network model and data pertaining to the incoming list of actors; calculating a weighted score based on the first score and the second score; and determining, based on the weighted score, whether scanning the incoming list of actors against a list of users for matches will cause a number of the matches to exceed a predefined threshold.

Yet another aspect of the present disclosure involves a non-transitory machine-readable medium having stored thereon machine-readable instructions executable to cause a machine to perform operations comprising: accessing first data pertaining to a plurality of first entities that have been previously associated with a flagged activity; identifying, at least in part by performing a clustering algorithm on the first data, a subset of the first entities that have met a predefined criterion, wherein the subset of the first entities have attributes that are in textual format; generating a multi-dimensional matrix having a plurality of vectors, wherein the vectors are obtained by applying a word2vec algorithm to the attributes of the subset of the first entities; training a Convolutional Neural Network (CNN) model with the multi-dimensional matrix; accessing second data pertaining to an incoming list that contains a plurality of second entities that have been flagged for engaging in, or having engaged, the flagged activity; and predicting, at least in part based on the trained CNN model, whether scanning the second data against a plurality of third entities for matches will cause a number of alerts to exceed a predefined threshold, wherein each of the alerts corresponds to a match that needs further investigation, and wherein each of the alerts is associated with a predefined geographical location or with a predefined language.

The foregoing disclosure is not intended to limit the present disclosure to the precise forms or particular fields of use disclosed. As such, it is contemplated that various alternate embodiments and/or modifications to the present disclosure, whether explicitly described or implied here, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing first data pertaining to a plurality of first entities that have been previously associated with a predefined activity;
identifying, at least in part by executing a clustering algorithm with the first data, a subset of the first entities that have met a predefined criterion;
generating, via a Natural Language Processing (NLP) technique, a multi-dimensional matrix having a plurality of vectors that are associated with attributes of the subset of the first entities;
training a neural network model using the multi-dimensional matrix;
accessing second data pertaining to a plurality of second entities on a list that contains entities that have been flagged for engaging, or having engaged, in the predefined activity; and
predicting, at least in part based on an output of the trained neural network model, whether scanning the second data against a plurality of third entities for matches will cause a number of alerts having a predefined characteristic to exceed a predefined threshold, wherein each of the alerts corresponds to a match that indicates further investigation.

2. The method of claim 1, wherein:
the predefined activity comprise a flagged activity;
the accessing the second data comprises obtaining the list of the second entities from an aggregator; and
the third entities are current users of a service provider.

3. The method of claim 1, wherein the clustering algorithm comprises a K-means algorithm.

4. The method of claim 1, wherein the subset of the first entities comprises first entities that have previously generated matches with the third entities that exceeded the predefined threshold.

5. The method of claim 1, wherein the attributes are in textual format, and wherein the multi-dimensional matrix is generated by applying a word2vec algorithm as the NLP technique to convert the attributes in textual format into the vectors of the multi-dimensional matrix.

6. The method of claim 1, wherein the training the neural network model comprises running the multi-dimensional matrix through successive Convolutional Neural Network (CNN) model layers.

7. The method of claim 1, wherein the predefined characteristic comprises a geographical region associated with the matches or a language associated with the matches.

8. The method of claim 1, further comprising:
training a regression model at least in part using the first data; and
forecasting, at least in part based on an output of the regression model, a total volume of the alerts.

9. The method of claim 8, wherein the predicting further comprises:
calculating a first score based on the forecasted total volume;
determining a correlation between attributes of the subset of the first entities and attributes of the second data; and
calculating a second score based on the correlation, wherein the prediction is based on a sum of the first score and the second score exceeding a predefined score.

10. The method of claim 9, further comprising: tuning the neural network model via a feedback loop.

11. A system, comprising:
a non-transitory memory; and
one or more hardware processors coupled to the non-transitory memory and configured to read instructions from the non-transitory memory to cause the system to perform operations comprising:
accessing data pertaining to an incoming list of actors that are currently flagged for engaging in one or more predefined activities;
accessing historical data pertaining to a plurality of actors that have previously engaged in the one or more predefined activities;
performing a first machine learning process at least in part by using a regression model trained on the historical data;
calculating a first score using the trained regression model and the data pertaining to the incoming list of actors;
performing a second machine learning process at least in part by using a neural network model trained on the historical data;
calculating a second score using the trained neural network model and the data pertaining to the incoming list of actors;
calculating a weighted score based on the first score and the second score; and
predicting, based on the weighted score, whether scanning the incoming list of actors against a list of users for matches will cause a number of the matches to exceed a predefined threshold.

12. The system of claim 11, wherein the historical data comprises historical data of actors that, when scanned against the list of users, caused the number of the matches to exceed the predefined threshold.

13. The system of claim 11, wherein:
the historical data comprises historical data associated with a predefined geographical region or with a predefined language; and
the regression model is a Gradient Boosting model.

14. The system of claim 11, wherein:
the accessing the data pertaining to the incoming list of actors further comprises extracting a number of entities that changed between the incoming list and a prior version of the list; and
the calculating the first score further comprises predicting a number of the matches by inputting the extracted number of the entities that changed into the trained regression model, wherein the first score is calculated based on the predicted number of the matches.

15. The system of claim 11, wherein:
the accessing the data pertaining to the incoming list of actors further comprises extracting attributes of entities that changed between the incoming list and a prior version of the list; and
the calculating the second score further comprises determining a correlation between the extracted attributes and attributes of the actors that have previously engaged in the one or more predefined activities, the determining the correlation comprising inputting the extracted attributes into the trained neural network model, wherein the second score is calculated based on the determined correlation.

16. The system of claim 11, wherein the neural network model comprises a Convolutional Neural Network (CNN) model, and wherein the neural network model is further trained based on:
generating a multi-dimensional matrix of vectors, the vectors being associated with attributes of the actors that have previously engaged in the one or more predefined activities; and
passing the multi-dimensional matrix through successive layers of the CNN model.

17. The system of claim 16, wherein the generating the multi-dimensional matrix comprises executing a word2vec algorithm using the attributes of the actors that have previously engaged in the one or more predefined activities, wherein the attributes are in a textual format before the word2vec algorithm is executed.

18. A non-transitory machine-readable medium having stored thereon machine-readable instructions executable to cause a machine to perform operations comprising:
accessing first data pertaining to a plurality of first entities that have been previously associated with a flagged activity;
identifying, at least in part by executing a clustering algorithm on the first data, a subset of the first entities that have met a predefined criterion, wherein the subset of the first entities have attributes that are in textual format;
generating a multi-dimensional matrix having a plurality of vectors, wherein the vectors are obtained by executing a word2vec algorithm using the attributes of the subset of the first entities;
training a Convolutional Neural Network (CNN) model with the multi-dimensional matrix;
accessing second data pertaining to an incoming list that contains a plurality of second entities that have been flagged for engaging, or having engaged, in the flagged activity; and
predicting, at least in part based on an output of the trained CNN model, whether scanning the second data against a plurality of third entities for matches will cause a number of alerts to exceed a predefined threshold, wherein each of the alerts corresponds to a match that indicates further investigation, and wherein each of the alerts is associated with a predefined geographical location or with a predefined language.

19. The non-transitory machine-readable medium of claim 18, wherein the operations further comprise:
training a regression model with the first data;
determining, based on the second data, a list of entities that changed between the incoming list and a prior version of the list; and
calculating a first score based on the list of entities that changed and the trained regression model, wherein the predicting is performed at least in part using the first score.

20. The non-transitory machine-readable medium of claim 19, wherein the predicting further comprises calculating a second score based on the list of entities that changed and the trained CNN model, and wherein the predicting is performed at least in part by comparing a sum of the first score and the second score with a predefined threshold score.
